(19) United States
(12) Patent Application Publication
(10) Pub. No.: US 2004/0145787 A1
(43) Pub. Date: Jul. 29, 2004

(54) Method for calibrating color image scanners

(76) Inventor: Ta-Wei Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/759,052

(22) Filed: Jan. 20, 2004

Related U.S. Application Data
(63) Continuation-in-part of application No. 09/653,314, filed on Sep. 1, 2000.

(51) Int. Cl. H04N 1/48

(52) U.S. Cl. 358/504; 358/505

(57) ABSTRACT

A method for calibrating a color image scanner is disclosed. A colorful calibration chart is installed on the surface of the scan window of a color image scanner. Then, according to the sensed signal of the calibration chart, the parameter of a converting circuit of an optic mechanical module is adjusted with a feedback loop so that the quality of the output color from the image scanning system can be retained in a predetermined level. Therefore, the defect from the manual adjustment in the prior art is removed and it is performed without increasing cost, and is economical.

### CROSS REFERENCE TO RELATED APPLICATION

This application is a continuation-in-part of U.S. application Ser. No. 09/653,314, filed on 1 Sep. 2000 and entitled “method for calibrating color image scanners”.

### FIELD OF THE INVENTION

The present invention relates to a method for calibrating a color image scanner, and especially to a calibration method for keeping a constant color scanning quality of an image scanner.

### BACKGROUND OF THE INVENTION

Since the properties of the sensors (not shown) are different, before being sold, the colors of each image scanning system (for example, scanners, color copiers, etc) must be calibrated for assuring the correction of colors in the image scanning system.

Referring to FIG. 1, a schematic view of a conventional image scanning system. In the figure, the image scanning system 40 has a scanner body 42, and a cover 44. The scanner body 42 has a scan window 46, a driving unit 48 and an optic mechanical module 60. The scan window 46 serves to receive documents to be scanned (not shown). The optic mechanical module 60 has a detection circuit and a converting circuit (not shown) for scanning aforesaid document. The driving unit 48 serves to drive the optic mechanical module 60 so as to travel under the scan window 46. In the conventional color calibration procedure, a calibration chart 50 with standard white color is installed on the surface of the scan window 46 in the image scanning system 40. When a normal image scanning system 40 scans, the respective signal of the calibration chart 50 with a standard while color will be detected by the image scanning system 40 and it is determined whether this signal is within a standard range. Therefore, it is easily to adjust the correction of the colors from the image scanning system 40 and thus the parameters of related circuit can be adjusted. However, in the image scanning system, since the calibration chart 50 is a standard white color slice, it can not be used to exactly calibrate the three primitive colors, red, green, and blue. In some extent, a standard white color is formed by linear combination of the vectors of the red, green and blue colors and the error for each primitive color can't be response correctly. Namely, in the image scanning system, even a color calibration process is performed accurately, the quality of output color can still not be assured. Therefore, when the user finds some faults in scanning an image, a manual adjustment to calibrate the colors of an image scanning system is required. Not only the cost is increased, but also the quality can not be well controlled.

### SUMMARY OF THE INVENTION

Accordingly, the primary object of the present invention is to provide a method for calibrating a color image scanner. Thereby, the defect from the manual adjustment in the prior art is removed. In the present invention, a colorful calibration chart is installed on the surface of the scan window of a color image scanner. Then, according to the sensed signal of the calibration chart, the parameter, e.g. gain, of a converting circuit of an optic mechanical module is adjusted with a feedback loop so that the quality of the output color from the image scanning system can be retained in a predetermined level.

Another object of the present invention is to provide a method for calibrating a color image scanner, the defect from the manual adjustment in the prior art is removed. The color of the image scanner can be calibrated automatically so as to improve the quality of the output image. And thus, it is performed without increasing cost, and is economical.

For reaching the objectives above, the present invention proposes a method for calibrating a color image scanner. A colorful calibration chart is installed on the surface of the scan window of a color image scanner. Then, according to the sensed signal of the calibration chart, the parameter, e.g. gain, of a converting circuit of an optic mechanical module is adjusted with a feedback loop so that the quality of the output color from the image scanning system can be retained in a predetermined level. Therefore, the defect from the manual adjustment in the prior art is removed and it is performed without increasing cost, and is economical.

The various objects and advantages of the present invention will be more readily understood from the following detailed description when reading in conjunction with the appended drawing.

### BRIEF DESCRIPTION OF THE DRAWINGS

FIG. 1 is a schematic view of a conventional image scanning system.

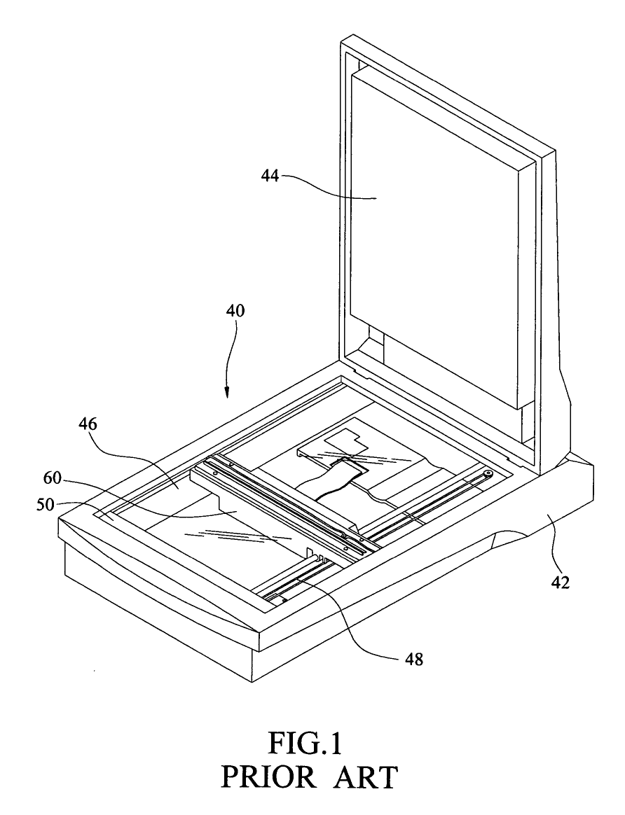

FIG. 2 is a schematic view of an image scanning system according to the present invention.

FIGS. 2a˜c are schematic diagrams of calibration charts according to the present invention.

FIG. 3 is a detailed operative flow of a preferred embodiment of the method for calibrating the color image scanning system complied with the present invention.

FIG. 4 is a operative flowchart for adjusting gain in the present invention.

### DETAILED DESCRIPTION OF THE PREFERRED EMBODIMENTS

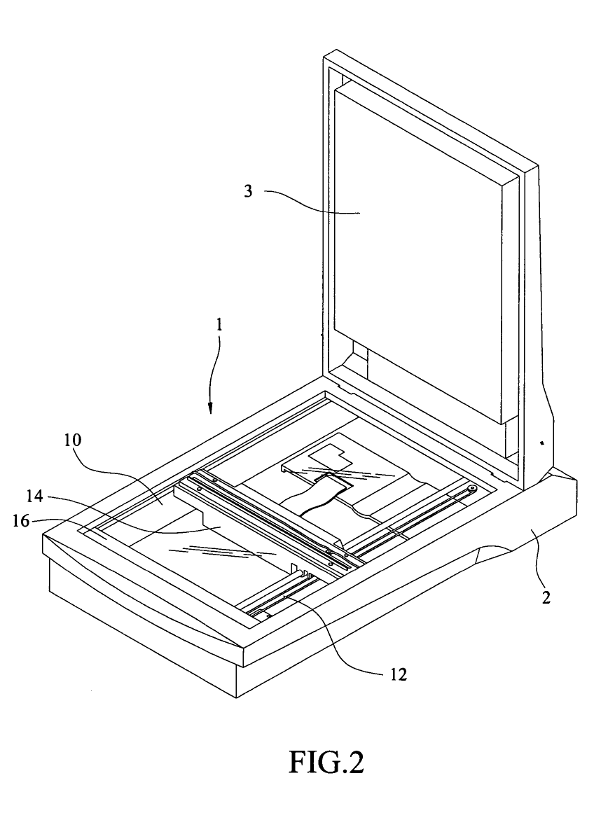

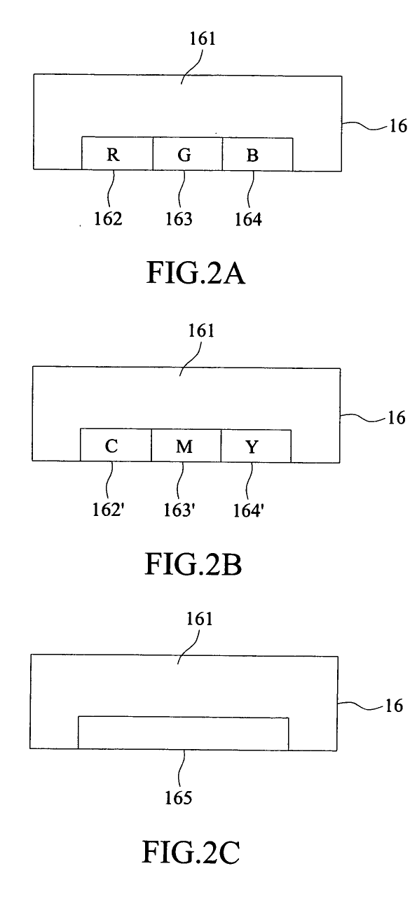

With reference to FIG. 2, a color image scanning system of the present invention is illustrated herein. The color image scanning system 1 is formed by a scanner body 2 and an upper cover 3. The scanner body 2 has a scan window 10, a driving unit 12 and an optic mechanical module 14. The scan window 10 serves to receive documents to be scanned (not shown). The optic mechanical module 14 includes imagine sensors and a converting circuit (for example, analog/digital converter) for detecting the document to be scanned and converting the sensed signal into a digital signal. The driving unit 12 serves to drive the optic mechanical module 14 so as to be traveled under the scan window 10.

The present invention is different from the conventional calibration method. In the present invention, a colorful calibration chart 16 is placed on the surface of the scan window 10, and then the sensed signal of the calibration chart 16 is used to calibrate the parameter of the converting circuit.

Please refer to FIGS. 2a˜c. There are tree embodiments of the calibration chart 16. In FIG. 2a, the calibration chart 16 has three primitive color regions 162,163 and 164, whose colors are red (R), green (G) and blue (B), respectively. These three colors are not necessary to be pure colors, i.e. not necessary to be saturated colors. Further, the calibration chart 16 has a white region 161, which is used for shading as well known in the prior art.

The embodiment in FIG. 2b is similar to that in FIG. 2a. The only difference is that the colors of the three primitive color regions 162′, 163′ and 164′ are cyan (C), magenta (M) and yellow (Y).

The embodiment in FIG. 2c is also similar to that in FIG. 2a. The only difference is that the calibration chart 16 only has a primitive color region 165, whose color is a non-saturated color or gray.

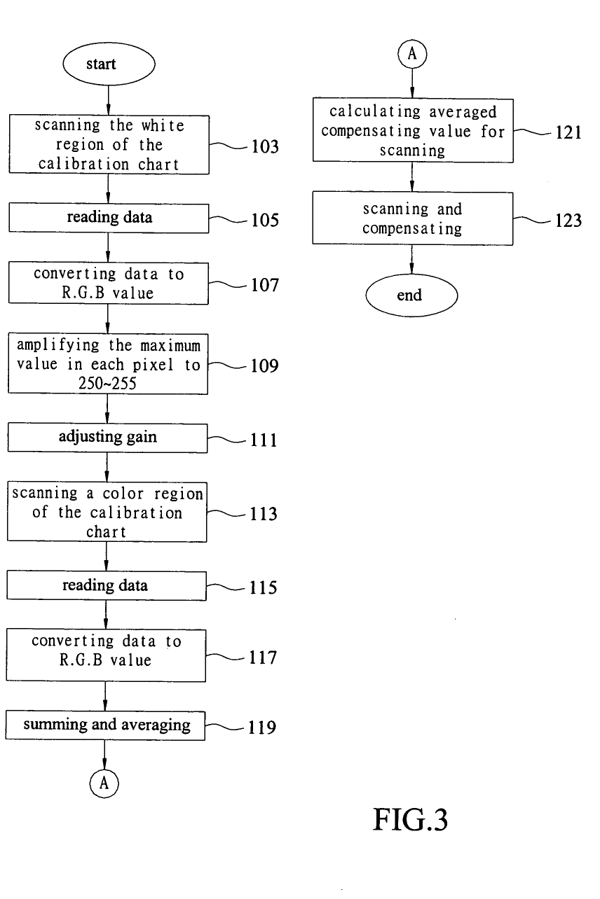

Please refer to FIG. 3, which is a detailed operative flow of a preferred embodiment of the method for calibrating the color image scanning system complied with the present invention. As an example, this embodiment employs the calibration chart 16 with the primitive colors of red (R), green (G) and blue (B) shown in FIG. 2A. The method includes following steps:

Step 103: scanning the white region of the calibration chart 16.

Step 105: reading data by using the image sensors on the circuit board of the optic mechanical module 14.

Step 107: converting data to R.G.B. value by using analog-to-digital converters (A/D converter).

Step 109: amplifying the maximum value in each pixel to 250˜255 (the maximum region), wherein each pixel is represented by 8 bits in this embodiment.

Step 111: adjusting gain.

Step 113: scanning a color region of the calibration chart 16.

Step 115: reading data.

Step 117: converting data to R.G.B. value.

Step 119: summing and averaging.

Step 121: calculating averaged compensating value for scanning.

Step 123: scanning and compensating.

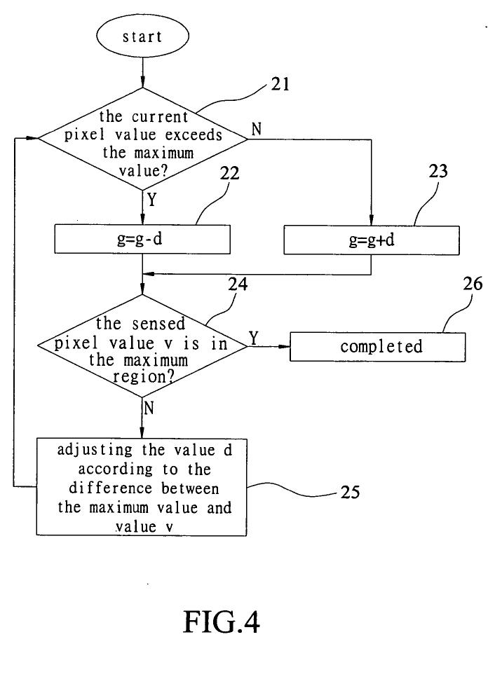

Please refer to FIG. 4, which is a operative flowchart for adjusting gain in the present invention. In step 111, assume a sensed value of a pixel is v and current gain is g, then the adjusted volume is d. Therein, the value of d can be modified according to different situations. The step 111 includes following steps:

Step 21: checking if the current pixel value exceeds the maximum value. If positive, perform step 22. Otherwise, perform step 23.

Step 22: g=g−d.

Step 23: g=g+d.

Step 24: checking if the sensed pixel value v is in the maximum region. If positive, jump to step 26. Otherwise, perform step 25.

Step 25: adjusting the value d according to the difference between the maximum value and value v. If the difference is large, magnify the value d. Otherwise, minify the value d. Then, jump back to step 21.

Step 26: gain adjusting process is completed.

In the step 121 described above, the image sensors of the optic mechanical module 14 not only can respectively sense a unique color such as R, G or B, but also can sense a little optical power of other colors. That results from properties of filter lens or light source. Hence, the sensing values are still influenced by other optical spectrums. For example, if an image sensor is used for sensing red, it not only can sense the optical power of red, but also can sense a little optical power of blue or green. Consequently, if the sensing value is (R, G, B) and the real value is (r, g, b), their relation can be expressed as:

R=a₁₁*r+a₁₂*g+a₁₃*b+c₁ (1)

G=a₂₁*r+a₂₂*g+a₂₃*b+c₂ (2)

B=a₃₁*r+a₃₂*g+a₃₃*b+c₃ (3)

Therein, aᵢⱼ(i, j=1, 2, 3) are relative coefficients between the sensed colors and real colors, c₁, c₂, c₃ are the minimum values that can be sensed (these values are the sensing values of black color).

The equations (1)˜(3) can be expressed by matrices as following:

[R [symbol] G [symbol] B]^{T}=A[r [symbol] g [symbol] b]^{T}+C (4)

wherein matrices A and C can be written as:

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] \qquad C = [ \begin{matrix}{c}_{1} \\ {c}_{2} \\ {c}_{3}\end{matrix} ]$$

Since the real colors in the calibration chart 16 are known, we can use the sensed colors and real colors to obtain the matrices A and C.

Moreover, due to the obtained transfer function (4), we can get the correct colors in the step 123 by using the scanned image and the following reverse function:

[r [symbol] g [symbol] b]^{T}=A⁻¹([R [symbol] G [symbol] B]^{T}−C)

Thereby, the correct colorful image can be obtained.

In summary, the method for calibrating a color image scanner according to the present invention has the following advantages:

1) The defect from the manual adjustment in the prior art is removed.

2) The colors of the image scanner can be calibrated automatically so as to improve the quality of the output image.

3) The method of the present invention is performed without increasing cost, and is economical.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for calibrating a color image scanner, comprising:
scanning a white region of a calibration chart;
reading first data;
converting the first data to first R.G.B. value;
amplifying a maximum value in each pixel to a predetermined region;
adjusting gain;
scanning a color region of the calibration chart;
reading second data;
converting the second data to second R.G.B. value;
summing and averaging;
calculating averaged compensating value for scanning; and
scanning and compensating.

2. The method as claimed in claim 1, wherein the first or second data is accessed by using a image sensor.

3. The method as claimed in claim 1, wherein the first or second data is converted to the first or second R.G.B. value by using an analog/digital converter (A/D converter).

4. The method as claimed in claim 1, wherein the pixel is represented by 8 bits and the maximum value is set within 250˜255.

5. The method as claimed in claim 1, wherein the step of adjusting gain further comprises:
checking if a current pixel value exceeds the maximum value;
subtracting an adjusted volume from a current gain value when the current pixel value exceeds the maximum value;
adding the adjusted volume to the current gain value when the current pixel value is smaller than or equal to the maximum value;
checking if a sensed pixel value is in the predetermined region, and
adjusting the adjusted volume according to difference between the maximum value and sensed pixel value.

6. The method as claimed in claim 1, wherein the step of calculating averaged compensating value is performed by using a relation between a sensing value (R, G, B) and a real value (r, g, b), the relation is:
R=a₁₁*r+a₁₂*g+a₁₃*b+c₁ (1)
G=a₂₁*r+a₂₂*g+a₂₃*b+c₂ (2)
B=a₃₁*r+a₃₂*g+a₃₃*b+c₃ (3)
wherein aᵢⱼ(i, j=1, 2, 3) are relative coefficients between the sensing value and real value, c₁, c₂, c₃ are minimum values of the sensing value.

7. The method as claimed in claim 6, wherein the equations (1)˜(3) are expressed via matrices as following:
[R [symbol] G [symbol] B]^{T}=A[r [symbol] g [symbol] b]^{T}+C (4)
wherein matrices A and C are written as:
$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] \qquad C = [ \begin{matrix}{c}_{1} \\ {c}_{2} \\ {c}_{3}\end{matrix} ] .$$

8. The method as claimed in claim 7, wherein the step of scanning and compensating is performed by using a reverse function of equation (4) as:
[r [symbol] g [symbol] b]^{T}=A⁻¹([R [symbol] G [symbol] B]^{T}−C)
whereby the real value (r, g, b) is obtained.
